(19) United States
(12) Patent Application Publication
(10) Pub. No.: US 2006/0069329 A1
(43) Pub. Date: Mar. 30, 2006

(54) Waterproof massage device with removable battery compartment

(75) Inventor: Simon Siu Man Nan, Richmond Hill (CA)

Correspondence Address: GREENSFELDER HEMKER & GALE PC, SUITE 2000, 10 SOUTH BROADWAY, ST LOUIS, MO, 63102, US

(73) Assignee: NANMA MANUFACTURING CO. LTD.

(21) Appl. No.: 10/950,935

(22) Filed: Sep. 27, 2004

(51) Int. Cl. A61H 1/00

(52) U.S. Cl. 601/72; 601/70; 601/69; 601/67

(57) ABSTRACT

A massage device with a waterproof and removable battery compartment that enables at least one battery to be removed or installed from the device is disclosed. The massage device comprises a body with middle, proximal, and distal portions. The removable battery compartment enables battery(s) to be installed or removed from the proximal portion of the body while providing a waterproof capability. In the preferred embodiment, the removable battery compartment is installed by a simple twist and slide motion.

### FIELD OF THE INVENTION

The present invention relates to a battery powered massage device, and more particularly to a battery powered massage device that is waterproof.

### BACKGROUND OF THE INVENTION

Battery powered massage devices used for sexual stimulation are well known in the art. A prior art battery powered massage device may comprise a body having a distal portion in communication with a proximal portion. The distal portion can include a vibratory element powered by batteries stored in the proximal portion of the body. Although prior art battery powered massage devices offer the usual advantage in that such devices do not require an electrical chord to be connected to an electrical outlet, operation of such devices may be hindered by the constant need for the user to replace one or more batteries that power the device. Replacing the batteries may be a cumbersome task because each and every battery must be individually installed at the proper orientation into an integral battery compartment that is accessed through a door of the massage device.

In addition, it may be desirable that such battery operated massage devices be capable of operation in wet environments such as swimming pools, showers, and bathtubs. However, most prior art battery powered massage devices are not waterproof, nor is there any provision for a removable battery compartment that provides a water-tight seal when engaged to the device.

Therefore, there is a need in the art for a battery powered massage device that enables one or more batteries to be installed or removed simultaneously from the massage device using a removable battery compartment. There also is a further need in the art for a battery powered massage device that has a removable battery compartment that provides a water-tight seal upon engagement with the device.

### OBJECT AND SUMMARY OF THE INVENTION

A primary object of the present invention is to provide a battery powered massage device with a removable battery compartment.

Another object of the present invention is to provide a battery powered massage device that is waterproof.

A further object of the present invention is to provide a waterproof battery powered massage device that includes a removable battery compartment that provides a water-tight seal upon engagement with the device.

Yet another object of the present invention is to provide a battery powered massage device with a removable battery compartment that is secured to the body of the massage device by a twist and slide motion.

These and other objects of the present invention are realized in an embodiment of the present invention, described by way of example and not by way of limitation, which provides for a massage device comprising a body, a motor encased in the body and operatively engaged to an element of the body with the motor adapted for driving the element, and a removable battery compartment engaged to the body. The removable battery compartment contains at least one battery for providing power to the motor.

According to another aspect, the present invention comprises a waterproof massage device comprising a body, the body operatively associated with a first element and a second element, a removable battery compartment engageable within the body, said removable battery compartment including a sealing member that forms a water-tight seal between said removable battery compartment and the body, and at least one battery disposed within the removable battery compartment for providing power to drive the first and second elements.

According to yet another aspect, the present invention comprises a removable battery compartment comprising a body including opposing distal and proximal end portions connected by a lateral element which collectively define a cavity adapted to receive at least one battery therein; at least one connection point capable of transmitting power from at least one battery, and a sealing member that forms a water tight seal when the removable battery compartment is engaged to the device.

### BRIEF DESCRIPTION OF THE DRAWINGS

FIG. 1 is a front view of the massage device according to the present invention;

FIG. 2 is a side view of the massage device according to the present invention;

FIG. 3 is an opposite partial cross sectional side view of the massage device illustrating the removable battery compartment according to the present invention;

FIG. 4 is an exploded view of the massage device according to the present invention;

FIG. 5 is an opposite partial cross sectional side view of the massage device with a prosthetic member placed over the rotating element and a rigid sleeve placed around the vibratory element according to the present invention;

FIG. 5A is an enlarged view of FIG. 5 illustrating the sealing member according to the present invention;

FIG. 6 is cross sectional view of the massage device taken along line 6-6 of FIG. 2 illustrating the removable battery compartment according to the present invention;

FIG. 7 is an end view of the proximal section of the massage device taken along line 7-7 of FIG. 1 according to the present invention;

FIG. 8 is a perspective view of the removable battery compartment according to the present invention; and

FIG. 9 is a perspective view of the removable battery compartment.

### DETAILED DESCRIPTION OF THE INVENTION

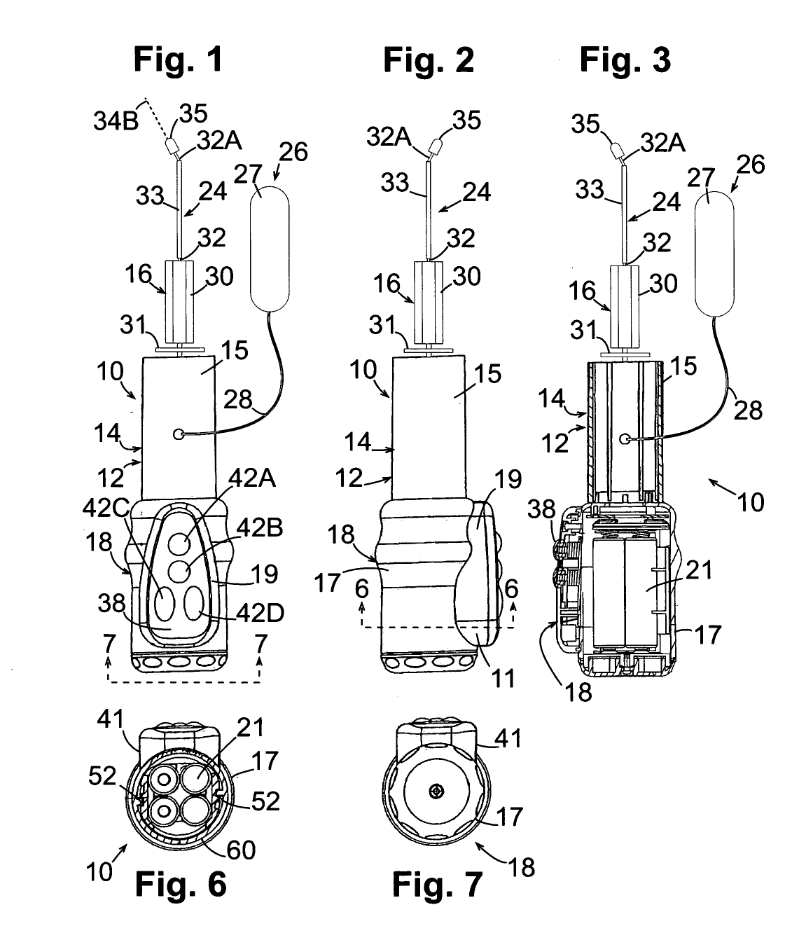

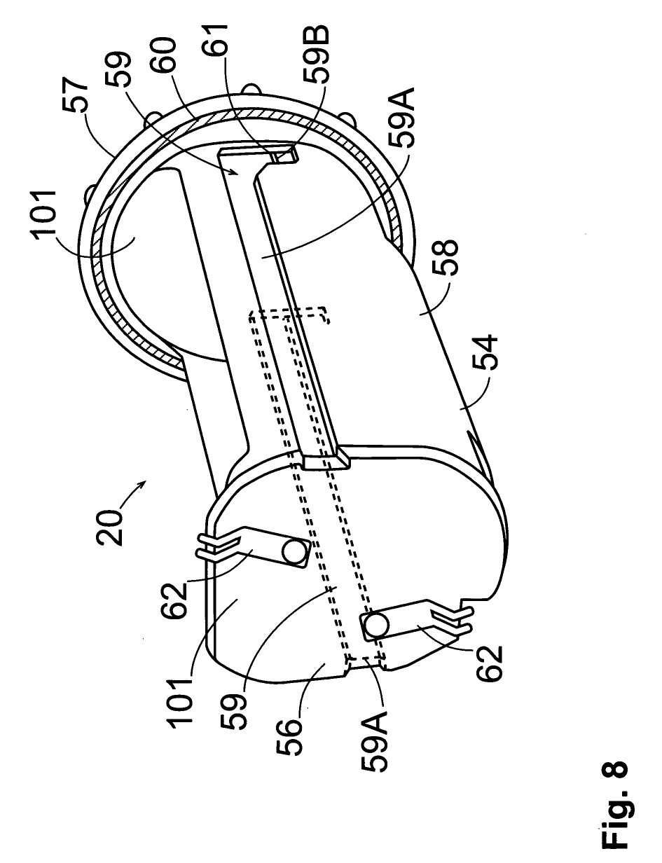

Referring to the drawings, a preferred embodiment of a battery powered massage device according to the present invention is illustrated and generally indicated as 10 in FIG. 1. The massage device 10 includes a removable battery compartment 20 (FIG. 8) that provides a water-tight seal with device 10 when engaged thereto.

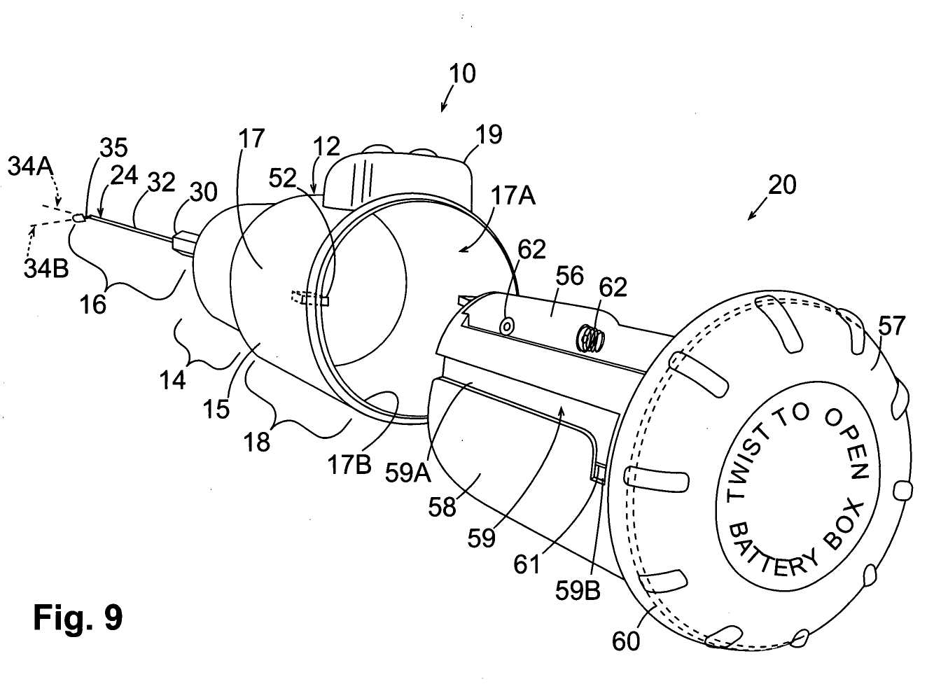

Referring to FIGS. 1-9, massage device 10 comprises a body 12 having a middle portion 14 interposed between a distal portion 16 and a proximal portion 18. The middle portion 14 comprises a sleeve 15 encasing a motor 22 operatively associated with a gearbox 23. Gearbox 23 is operatively engaged to a rotating element 24 to spin element 24 about a primary axis 34A (FIG. 9) when actuated by a user. The middle portion 14 further includes a vibratory element 26 operatively associated to the batteries 21 disposed inside the removable battery compartment 20 by an electrical cord 28. The rotating element 24 and vibratory element 26 are powered by at least one battery 21, and preferably by a plurality of batteries 21 disposed in the removable battery compartment 20 operatively engageable with proximal portion 18 of the massage device 10.

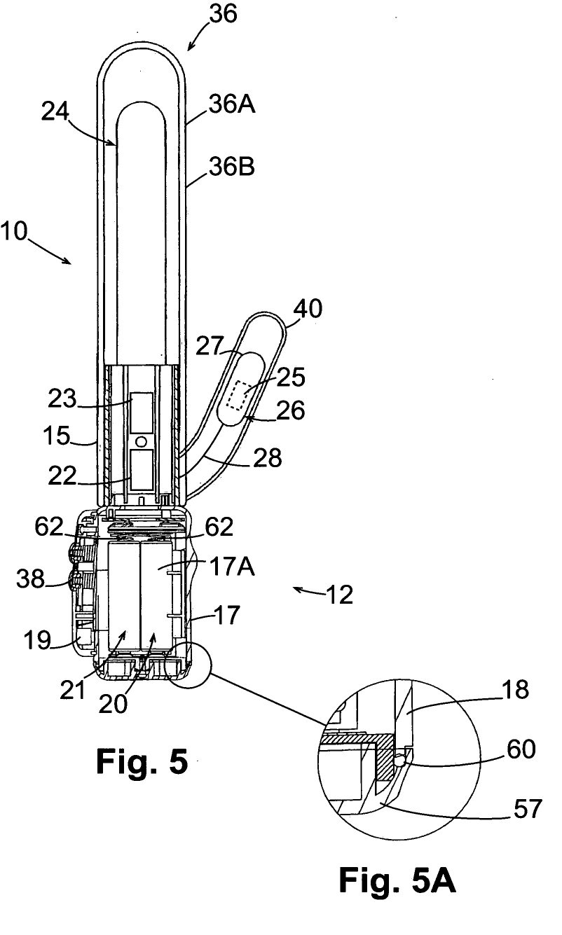

Proximal portion 18 comprises a circular housing 17 that defines a hollow cavity 17A with an open end 17B that is adapted to slidably receive removable battery compartment 20. Circular housing 17 further includes a set of tabs 52 to secure removable battery compartment 20 to hollow cavity 17A as explained in greater detail below. In the preferred embodiment, a sealing member 60, preferably made of a resilient material, such as an O-ring, is positioned between removable battery compartment 20 and proximal portion 18 to ensure that fluid, such as water, cannot enter hollow cavity 17A as illustrated in FIG. 5A.

Proximal portion 18 further defines a raised platform 19 which is secured to circular housing 17 by a plurality of screws 39 that engage a plurality of apertures 37. Raised platform 19 includes a user interface 38 which enables the user to control the speed and direction of rotating element 24 and degree of vibration of vibratory element 26. As further shown, a gasket 44 is positioned between raised platform 19 and circular housing 17 to provide a water-tight seal. A malleable plastic sheet 43 is placed on the top side of raised platform 19 to protect the user interface 38 from damage.

Referring to FIGS. 1 and 5, rotating element 24 spins about primary axis 34A when actuated by the user and comprises a hexagonal member 30 concentrically surrounding a rod 32. A sleeve 33 co-axially surrounds rod 32 for protecting rod 32. As further shown, rod 32 includes a rod 32A connected to a tip portion 35 set at an angle from primary axis 34A enabling tip portion 35 to spin about a secondary axis 34B such that a prosthetic member 36 engaged to distal portion 16 is caused to vibrate during operation of massage device 10. In the preferred embodiment, a circular plate 31 concentrically surrounds rod 32 and provides structural support for the hollow prosthetic member 36 when engaged to distal portion 16.

As shown in FIG. 5, hollow prosthetic member 36 can be placed over distal portion 14 24 and slidably engaged to hexagonal member 30 to completely encase rotating element 24. When the rotating element 24 is activated the tip portion 35 spins about secondary axis 34B and vibrates prosthetic member 36. In the preferred embodiment, a dildo (not shown) may be used as the prosthetic member 36; however, any number of different shapes and sizes of hollow prosthetic members may be used in the present invention.

Referring to FIGS. 1, 3, 4, and 5, the user can further enhance the massaging effect by operating vibratory element 26 which is operatively connected to middle portion 14 by electrical cord 28. Vibratory element 26 consists of a cylindrical-shaped body 27 that encases a motor 25 which is operatively associated with a vibratory component 28 (not shown). Motor 25 drives the vibratory component 28 to cause body 27 to vibrate when vibratory element 26 is actuated.

According to another aspect of the present invention shown in FIG. 5, vibratory element 26 and electrical cord 28 are adapted to be encased within a rigid sleeve 40 that is attached to middle portion 14. Rigid sleeve 40 is a tube-shaped extension that may be vibrated by the action of vibratory element 26 when actuated. In operation, rigid sleeve 40 can provide a massaging effect to one area of the user's body while prosthetic member 36 massages another area of the user's body.

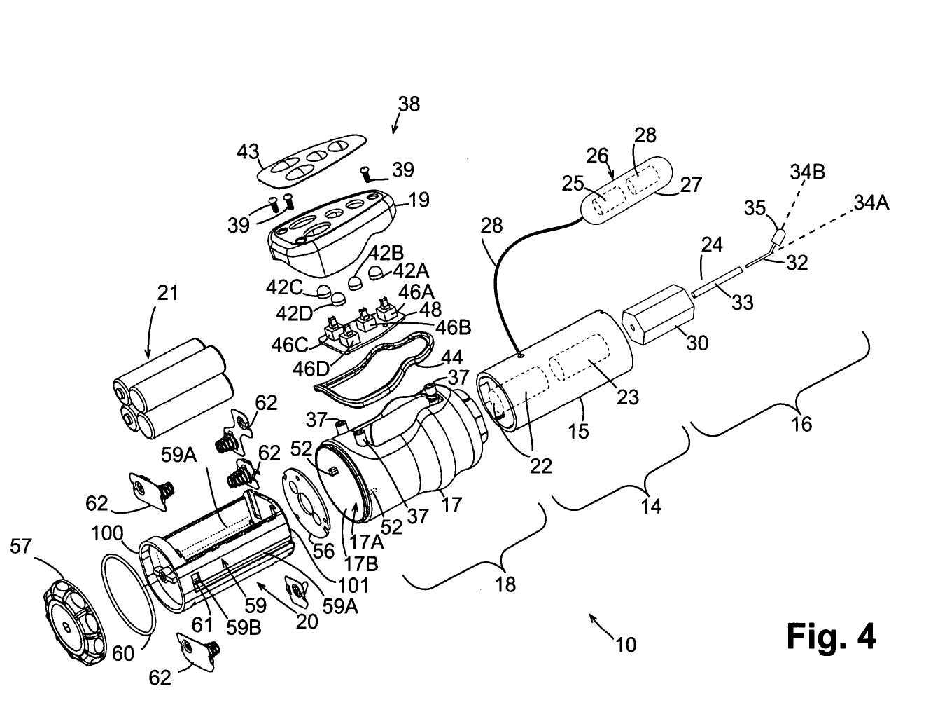

Referring to FIGS. 4, and 6-9, removable battery compartment 20 comprises a housing 54 with opposing distal and proximal end portions 100 and 101 with the distal end portion 100 being engageable to a cap member 57 and the proximal end portion 101 being engaged to a terminal plate 56. In the preferred embodiment, a sealing member 60 is provided at cap member 57 for providing a water-tight seal between cap 57 and opening 17B of proximal portion 18 such that fluid is prevented from entering hollow cavity 17A when removable battery compartment 20 is engaged to proximal portion 18.

As further shown, removable battery compartment 20 comprises a lateral element 58 that connects distal and proximal end portions 100, 101 and defines two slots 59 that engage or disengage tabs 52 of circular housing 17 of proximal portion 18 during installation or removal of removable battery compartment 20. Each slot 59 includes a horizontal section 59A and a vertical section 59B that are separated from one another by a lip 61. Cap member 57 and terminal plate 56 further include a set of connection points 62 to deliver power from batteries 21 to motors 22 and 25 when a particular circuit is completed by the engagement of respective switches 46A-46D on user interface 38 as described below.

In operation, the user installs the removable battery compartment 20 into proximal portion 18 by first aligning horizontal sections 59A with tabs 52 and then engaging removable battery compartment 20 into hollow cavity 17A by sliding the tabs 52 along corresponding horizontal slots 59A until cap member 57 contacts opening 17B of housing 17. The user then twists cap member 57 in a direction which forces tab members 52 over lip 61 and into vertical section 59B to engage removable battery compartment 20 into hollow cavity 17A. In this manner, the sealing member 60 provides a water-tight seal between the cap member 57 and proximal portion 18. Removable battery compartment 20 can be disengaged from hollow cavity 17A by twisting cap member 57 in a counter direction to disengage tab members 52 from vertical section 59B such that tab members 52 ride along horizontal section 59A. Pulling on cap member 57 allows for the complete removal of the removable battery compartment 20 from hollow cavity 17A.

As noted above, user interface 38 provides a means for operating massage device 10. User interface 38 comprises a series of buttons 42A-42D covered by malleable elastic sheet 43 that prevents fluid from entering body 12. Buttons 42A-42D enable the user to individually control the rotating element 24 and vibratory element 26, respectively. Specifically, button 42A enables the user to turn rotating element 24 to the “ON” position causing it to spin about primary axis 34A. Additionally, the user can change the direction of rotating element 24 by depressing button 42B. Vibratory element 26 can be turned “ON” or “OFF” by depressing button 42C. Finally, the user can adjust the speed of vibratory element 26 from a “HIGH” mode to a “LOW” mode by pressing button 42D. While specific functions have been described above for buttons 42A-42D, user interface 38 could have any number of buttons (or similar devices) that operate various elements of massage device 10.

When depressed, buttons 42A-42D engage a series of corresponding switches 46A-46D that are attached to a circuit board 48. Engaging any one of switches 46A-46D completes an electrical circuit to enable power from batteries 21 to be delivered through circuit board 48 to either motor 22 or motor 25. If power from batteries 21 is delivered to motor 22, motor 22 actuates gearbox 23, which rotates rotating element 24. In addition, when the motor 25 is powered, vibratory component 28 vibrates the body 27 of vibratory element 26 at the speed selected by the user.

It should be understood from the foregoing that, while particular embodiments of the invention have been illustrated and described, various modifications can be made thereto without departing from the spirit and scope of the invention as will be apparent to those skilled in the art. Such changes and modifications are within the scope and teaching of this invention as defined in the claims appended hereto.

What is claimed is:

1. A massage device comprising:
a body;
a motor encased in said body and operatively engaged to an element of said body, said motor adapted for driving said element; and
a removable battery compartment engaged with said body, said removable battery compartment containing at least one battery for providing power to said motor.

2. The massage device according to claim 1, wherein said removable battery compartment comprises a sealing member that forms a water-tight seal between said body and said removable battery compartment when said removable battery compartment is engaged to said body.

3. The massage device according to claim 2 wherein said sealing member is an O-ring.

4. The massage device according to claim 1 wherein said removable battery compartment includes a cap.

5. The massage device according to claim 4 wherein said cap includes a sealing member that forms an air-tight seal between said body and said removable battery compartment.

6. The massage device according to claim 4 wherein said removable battery compartment comprises distal and proximal end portions connected by a lateral element collectively defining a cavity.

7. A waterproof massage device comprising:
a body, said body operatively associated with a first element;
a second element connected to said body;
a removable battery compartment engageable within said body, said removable battery compartment including a sealing member that forms a water tight seal between said removable battery compartment and said proximal portion; and
at least one battery disposed within said removable battery compartment for providing power to drive said first and second elements.

8. The waterproof massage device according to claim 7 wherein said removable battery compartment includes a body that defines a slot member that is adapted to slidably engage a tab member located within said proximal portion upon the insertion of said removable battery compartment within said proximal portion.

9. The waterproof massage device according to claim 7 wherein said removable battery compartment comprises distal and proximal end portions connected together by a lateral element.

10. The waterproof massage device according to claim 9 wherein said sealing member is disposed along one of said end portions.

11. The waterproof massage device according to claim 7 wherein said removable battery compartment slides into said proximal portion and is secured to said body by a twisting motion.

12. The waterproof massage device according to claim 7 further comprising a user interface to enable the user to separately operate said first and second elements.

13. A removable battery compartment for a device comprising:
a body including distal and proximal end portions connected by a lateral element which collectively define a cavity adapted to receive therein at least one battery;
at least one connection point capable of transmitting power from said at least one battery;
a cap engageable to said proximal end portion; and
a sealing member engaged to said proximal end portion that forms a water-tight seal when said removable battery compartment is engaged to the device.

14. The removable battery compartment according to claim 13 wherein said sealing member is an O-ring.

15. The removable battery compartment according to claim 13 wherein said lateral element includes a slot member that is adapted to slidably engage a tab member located on said massage device.
